(19) United States
(12) Patent Application Publication
(10) Pub. No.: US 2020/0231111 A1
(43) Pub. Date: Jul. 23, 2020

(54) VEHICLE FOOTWELL REFLECTOR

(71) Applicant: Ford Global Technologies, LLC, Dearborn, MI (US)

(72) Inventors: MAHMOUD YOUSEF GHANNAM, Canton, MI (US); ADIL SIDDIQUI, Farmington Hills, MI (US)

(73) Assignee: Ford Global Technologies, LLC, Dearborn, MI (US)

(21) Appl. No.: 16/250,368

(22) Filed: Jan. 17, 2019

(51) Int. Cl. B60R 21/015; B60T 17/22; B60T 7/04; B60K 37/02; H04N 5/225

(52) U.S. Cl. CPC B60R 21/01552; B60T 17/22; B60R 21/01538; B60W 2540/12; B60K 37/02; H04N 5/2258; B60W 2420/403; B60T 7/042

(57) ABSTRACT

A system includes an image sensor disposed in a vehicle cabin, and a reflector disposed in the cabin and positioned to reflect a view of a footwell into a field of view of the image sensor.

### BACKGROUND

A vehicle may include a computer that receives data from one or more sensors, such as cameras, light detection and ranging (LIDAR) devices, etc. The data from the sensors may be used by the computer to operate the vehicle, e.g., in an autonomous mode or a semi-autonomous mode. Some sensors detect objects and/or occupants in a vehicle cabin. These sensors may be mounted inside the vehicle cabin.

### BRIEF DESCRIPTION OF THE DRAWINGS

FIG. 1A is a perspective view of a vehicle including one embodiment of a system having a reflector and an image sensor.

FIG. 1B is a field of view of the image sensor.

FIG. 2A is a perspective view of the vehicle including another embodiment of the system having the image sensor, a second image sensor, the reflector, and three second reflectors.

FIG. 2B is the field of view of the image sensor.

FIG. 2C is a second field of view of the second image sensor.

FIG. 3A is a perspective view of the vehicle including another embodiment of the system having the image sensor, the reflector, the second reflector, and a third reflector.

FIG. 3B is the field of view of the image sensor.

FIG. 4A is a perspective view of the vehicle including another embodiment of the system having the image sensor, the reflector, and the second reflector.

FIG. 4B is the field of view of the image sensor.

FIG. 5 is a view of the footwell reflected by the reflector.

### DETAILED DESCRIPTION

A system includes an image sensor disposed in a vehicle cabin and a reflector disposed in the cabin and positioned to reflect a view of a footwell into a field of view of the image sensor.

The reflector may be disposed in the footwell.

The image sensor may be disposed in the footwell.

The image sensor may be out of the footwell.

The system may include a light source disposed in the footwell.

The light source may be coupled to the reflector.

The reflector and the image sensor may be out of the footwell.

The system may include pedals disposed in the footwell. The view of the footwell may include the pedals.

The system may include a processor and a memory storing instructions executable by the processor to actuate a vehicle component based on capturing the view of the footwell reflected from the reflector.

The system may include a second image sensor spaced from the image sensor. The second image sensor may have a second field of view. A second reflector may be disposed in the cabin and positioned to reflect a second view of the footwell into the second field of view.

The system may include a second reflector disposed in the cabin and spaced from the reflector. The second reflector may be positioned to reflect a second view of the footwell into the field of view of the image sensor.

The system may include a second image sensor spaced from the image sensor. The second image sensor may have a second field of view. The reflector may be positioned to reflect the view of the footwell into the second field of view of the second image sensor.

The system may include a second reflector disposed in the cabin and spaced from the reflector. The second reflector may be positioned to reflect the view of the footwell to the reflector.

The system may include a second footwell spaced from the footwell and a third reflector disposed in the cabin. The third reflector may be positioned to reflect a view of the second footwell to the reflector. The reflector may be positioned to reflect the view of the second footwell into the field of view of the image sensor.

The system may include a second footwell spaced from the footwell, and a second reflector disposed in the cabin. The second reflector may be positioned to reflect a view of the second footwell into the field of view of the image sensor.

The image sensor may be an infrared image sensor.

The reflector may include infrared-reflective material.

The image sensor may be a visible-light camera.

The reflector may be a mirror.

With reference to the Figures, wherein like numerals indicate like parts throughout the several views, a vehicle 10 is shown. The vehicle 10 includes a sensing system 12 having an image sensor 14 disposed in a cabin 16, and a reflector 18 disposed in the cabin 16 and positioned to reflect a view 20 of a footwell 22 into a field of view 24 of the image sensor 14.

The reflector 18 may be positioned to provide the view 20 of the footwell 22 to one or more image sensors 14 disposed in the cabin 16, e.g., as part of a driver monitoring system (not shown) or other system using sensor 14 data. A driver monitoring system may analyze image data from one or more sensors 14, for example, to determine a driver readiness level, e.g., where a vehicle operator is looking, whether the vehicle operator is distracted, drowsiness of the vehicle operator, etc. The image sensors 14 may be positioned to face the vehicle operator, e.g., a torso or a head of the vehicle operator, but it may be impossible or impractical to position an image sensor 14 so that the field of view 24 of the image sensor 14 includes the view 20 of the footwell 22, i.e., to show feet of the vehicle operator. By reflecting the view 20 of the footwell 22 to the image sensor 14, the reflector 18 can provide a foot position of the vehicle operator, which can assist in confirming the driver readiness level as determined by the driver monitoring system, e.g., the foot position of the driver is within a predetermined area in the footwell 22. Additionally, the reflector 18 may reduce the total number of image sensors 14 needed to capture the entire cabin 16, including the footwell 22, and the reflector 18 may be easier to clean as compared to an image sensor 14 should the reflector 18 become dirty, smudged, etc., which can assist in reducing costs.

The vehicle 10 may be any suitable type of automobile, e.g., a passenger or commercial automobile such as a sedan, a coupe, a truck, a sport utility vehicle, a crossover vehicle, a van, a minivan, a taxi, a bus, etc. The vehicle 10, for example, may be an autonomous vehicle. In other words, the vehicle 10 may be autonomously operated such that the vehicle 10 may be driven without constant attention from a driver, i.e., the vehicle 10 may be self-driving without human input.

The vehicle 10 may include two sides 26, 28 spaced from each other in a cross-vehicle direction Dc. The sides 26, 28 of the vehicle 10 may be elongated in a vehicle fore-and-aft direction Da. Each side of the vehicle 10 may be similar or identical to each other.

The vehicle 10 includes a body 30 defining the cabin 16 that can house occupants, if any, of the vehicle 10. The cabin 16 includes a front end 32 and a rear end (not shown) with the front end 32 being in front of the rear end during forward movement of the vehicle 10. In other words, the front end 32 and the rear end of the cabin are spaced from each other in the vehicle fore-and-aft direction Da.

The cabin 16 includes one or more front seats 34, 36, including a driver seat 34 and a passenger seat 36, disposed at the front end 32 of the cabin 16. The cabin 16 can further include one or more back seats (not shown) disposed behind the front seats 34, 36. The cabin 16 may also include third-row seats (not shown) at the rear end of the cabin 16. In the Figures, the front seats 34, 36 are shown as bucket seats, but the front seats 34, 36 may be other types. The position and orientation of the front seats 34, 36 and components thereof, e.g., a seatback, a seat bottom, a head restraint, etc., may be adjustable by an occupant.

The cabin 16 may include an instrument panel 40 extending laterally across, i.e., in the cross-vehicle direction Dc, at the front end 32 of the cabin 16. The instrument panel 40 may be disposed forward of occupants, if any, of the cabin 16. In other words, the instrument panel 40 may be disposed in front of the front seats 34, 36 in the vehicle fore-and-aft direction. Said differently, the front seats 34, 36 typically face the instrument panel 40.

The body 30 includes a floor 38. The floor 38 may define a lower boundary of the cabin 16. The floor 38 may include the footwell 22. The floor 38 extends along a bottom of the cabin 16 and curves upward at the footwell 22 at the front end 32 of the cabin 16. In other words, the footwell 22 is at the front end 32 of the cabin 16. The footwell 22 may, for example, extend partially underneath the instrument panel 40.

The footwell 22 may be disposed forward of the occupants, if any, of the cabin 16. Specifically, the footwell 22 may be disposed in front of the front seat 34, 36. For example, the cabin 16 may include one footwell 22a, 22b disposed in front of each front seat 34, 36. Said differently, the floor 38 may include a first footwell 22a disposed in front of the driver seat 34 and a second footwell 22b disposed in front of the passenger seat 36. In other words, the second footwell 22b is laterally spaced from the first footwell 22a, i.e., in the cross-vehicle direction Dc. For example, the first footwell 22a is adjacent to one side 26 of the vehicle 10 and the second footwell 22b is adjacent to the other side 28 of the vehicle 10.

The vehicle 10 may include a center console 42, for example, separating the first footwell 22a and the second footwell 22b. In other words, the center console 42 may partially define each of the first footwell 22a and the second footwell 22b. Said differently, the first footwell 22a may extend from one side 26 of the vehicle 10 to the center console 42, and the second footwell 22b may extend from the center console 42 to the other side 28 of the vehicle 10.

The vehicle 10 may include a plurality of pedals 44, 46 disposed in the first footwell 22a, i.e., in front of the driver seat 34. For example, the plurality of pedals 44, 46 may include a brake pedal 44 and an accelerator 46. Additionally, the plurality of pedals 44, 46 may include a clutch, a parking brake, and/or any other suitable pedal. The pedals 44, 46 are typically engageable or operable by a foot of a vehicle operator.

The body 30 may include a roof 48. The roof 48 is above the floor 38. The roof 48 may include a panel (not shown) having outer surface at an exterior of the vehicle and an inner surface facing toward the cabin 16. The roof 48 may include a roof beam 50 adjacent the panel and extending between roof rails (not numbered), i.e., from one side 26 of the vehicle 10 to the other side 28 of the vehicle 10. The roof beam 50 may, for example, be disposed behind the front seats 34, 36. In other words, the front seats 34, 36 may be between the front end 32 of the cabin 16 and the roof beam 50 along the vehicle fore-and-aft direction.

The image sensor 14 is aimed at, i.e., is arranged to have the field of view 24 include, one or more seats, e.g., the front seats 34, 36, the back seats, etc. For example, the image sensor 14 may be fixedly mounted in a position in which one seat, e.g., one front seat 34, 36, is in the field of view 24 of the image sensor 14 regardless of how a position of the seat, e.g., one front seat 34, 36, is adjusted. For another example, the image sensor 14 may be movably mounted, e.g., by servomotors (not shown), and movement of the image sensor 14 may track adjustment of the position of the seat, e.g., one front seat 34, 36.

The image sensor 14 may be disposed in any suitable position in the cabin 16. For example, the image sensor 14 may be disposed in the footwell 22. Alternatively, as shown in the Figures, the image sensor 14 may be disposed out of the footwell 22, e.g., on the B-pillar, on the instrument panel 40 adjacent the windshield, on the roof beam 50, etc.

The image sensor 14 is attached in the cabin 16. The image sensor 14 may be attached to any suitable component in the cabin 16. For example, the image sensor 14 may be attached to a rear-view mirror and face rearward. For another example, the image sensor 14 may be mounted on or in the instrument panel 40, such as behind a steering wheel, centered on the instrument panel 40 near a bottom edge of a windshield, or positioned in front of one seat, e.g., one front seat 34, 36. For another example, the image sensor 14 may be mounted to the roof 48, e.g., near a sun visor, to the roof beam 50, etc. For another example, the image sensor 14 may be mounted in or near the footwell 22, e.g., to the floor 38, a side of the center console 42, an underside of the instrument panel 40, etc. As yet another example, the image sensor 14 may be mounted to the body 30, e.g., an A-pillar, a B-pillar, a door, etc. The image sensor 14 is attached to the cabin 16 in any suitable manner, e.g., fasteners.

The image sensor 14 outputs digital image data, typically in the form of video, i.e., a temporal sequence of images, e.g., digital frames or the like. As another example, the image sensor 14 may output data in the form of still images. The image sensor 14 may be any suitable type of image sensor. The image sensor 14 may detect electromagnetic radiation. For example, the image sensor 14 may detect some or all of the visible-light spectrum, i.e., the image sensor 14 may be a visible-light camera. Alternatively, or additionally, the image sensors 14 may detect some or all of the infrared and/or ultraviolet spectrum, i.e., the image sensor 14 may be an infrared image sensor and/or an ultraviolet image sensor. As yet another example, the image sensor 14 may be a radar sensor, a light detection and ranging (LIDAR) sensor, etc.

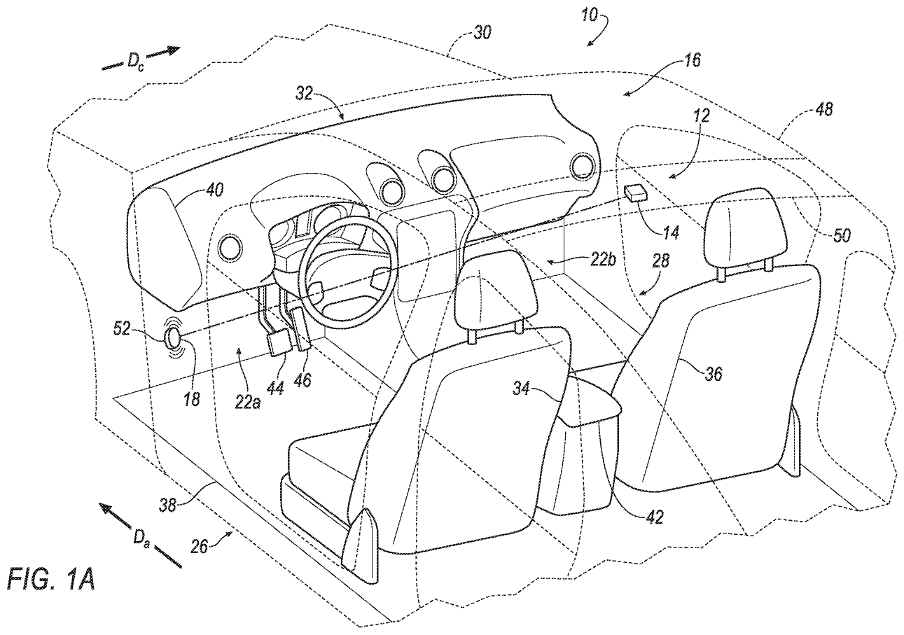

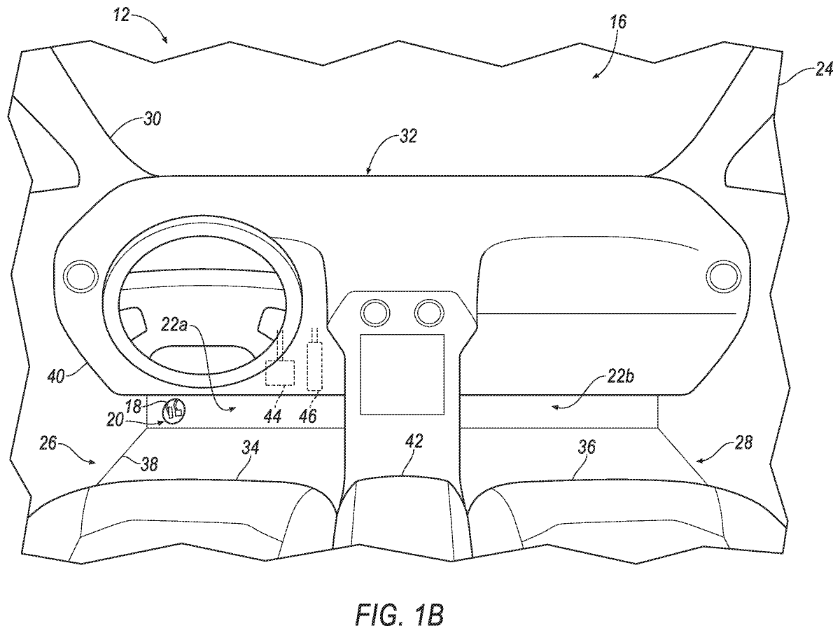

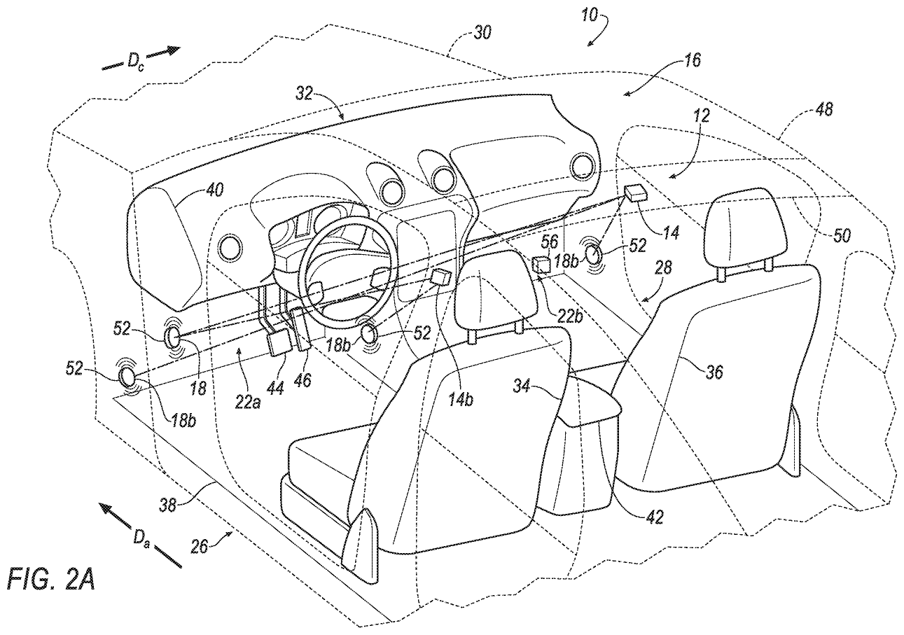

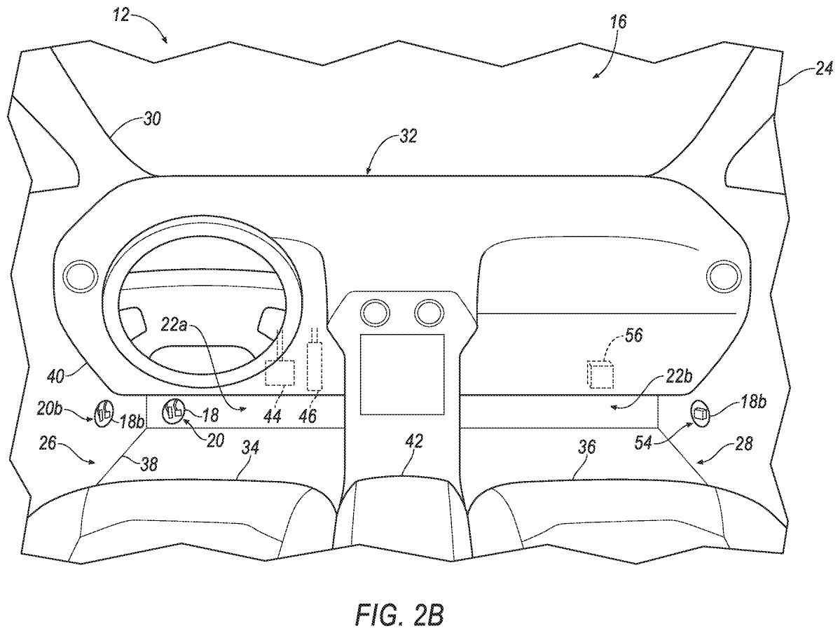

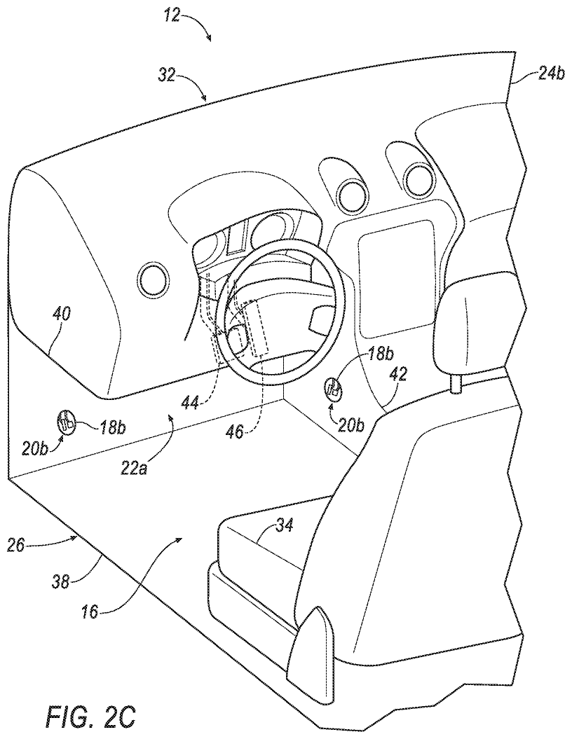

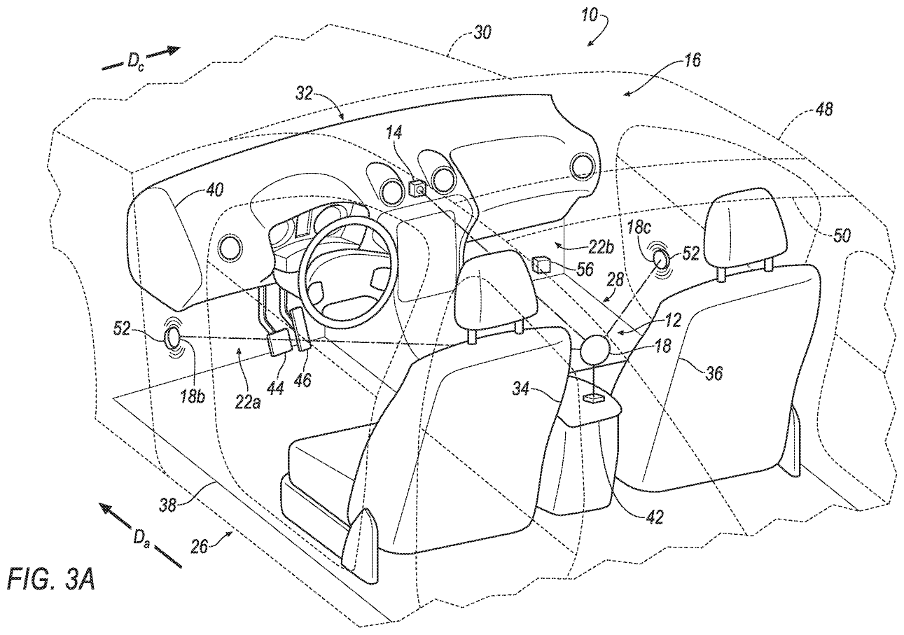

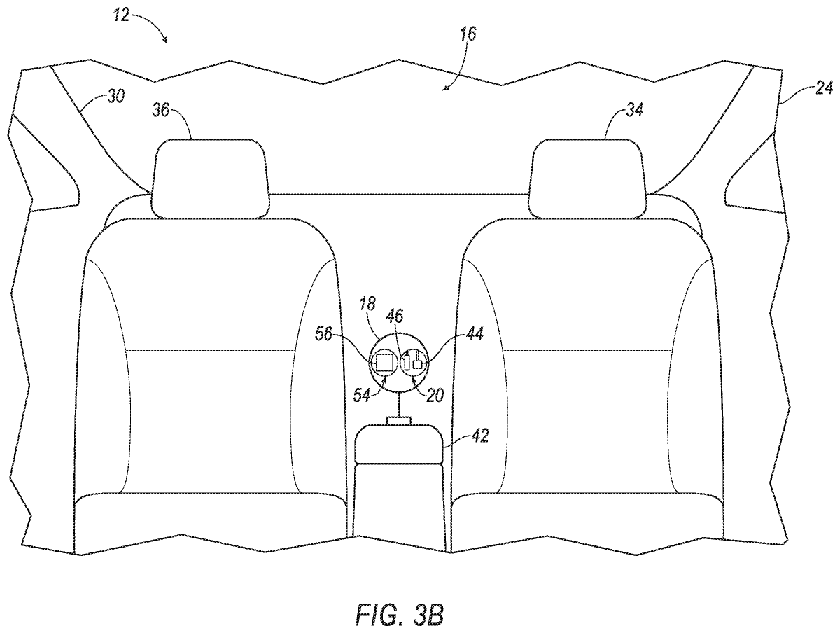

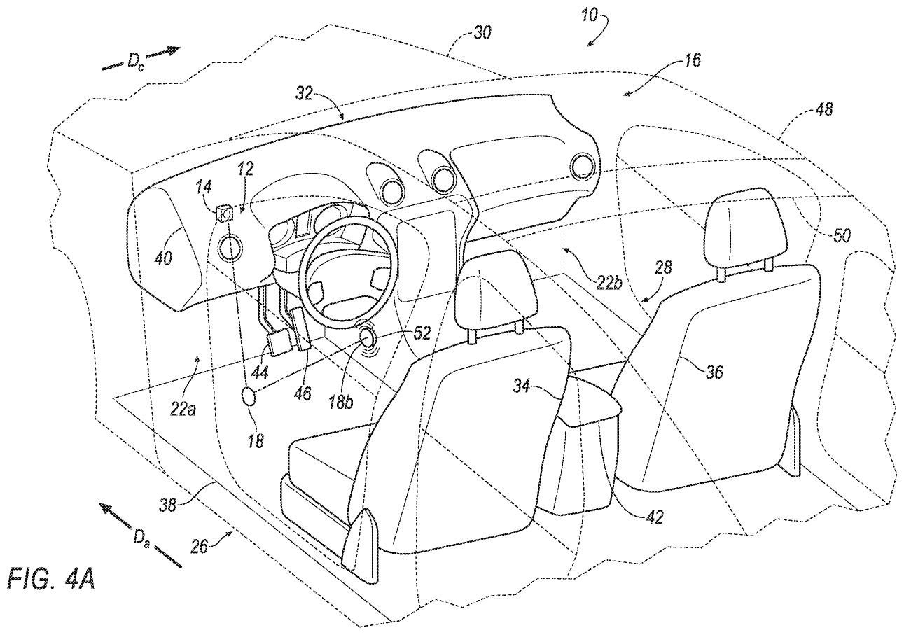

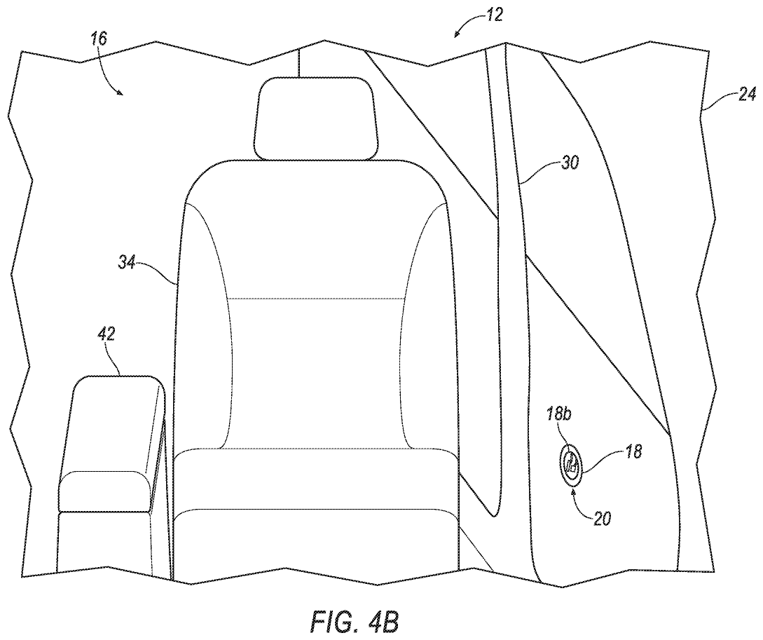

The system 12 may include any suitable number of image sensors 14. For example, the system 12 may include one image sensor 14, as shown in FIGS. 1A, 3A, and 4A. In such an example, the field of view 24 of the image sensor 14 may extend across the entire cabin 16, as shown in FIGS. 1B, and 3B. As another example, the field of view 24 of the image sensor 14 may extend partially across the cabin 16, as shown in FIG. 4B. Alternatively, the system 12 may include a plurality of image sensors 14, i.e., more than one image sensor 14, as shown in FIG. 2A. In such an example, one image sensor may be referred to as a second image sensor 14b.

The second image sensor 14b may be spaced from the image sensor 14. The second image sensor 14b may be disposed in any suitable position in the cabin 16, e.g., in the footwell 22, out of the footwell 22, etc. The second image sensor 14b may be attached in the cabin 16 in a same or different manner as the image sensor 14. The second image sensor 14b may be any suitable type of image sensor, e.g., a visible-light camera, an infrared image sensor, etc. The second image sensor 14b may be a same or different type of image sensor as the image sensor 14. The second image sensor 14b may be aimed at, i.e., arranged to have a second field of view 24b including, one or more of seats, e.g., the front seats 34, 36. The field of view 24 of the image sensor 14 may, for example, overlap the second field of view 24b of the second image sensor 14b, e.g., the field of view 24 of the image sensor 14 and the second field of view 24b of the second image sensor 14b each may include the driver seat 34. Alternatively, the field of view 24 of the image sensor 14 may be separate from the second field of view 24b of the second image sensor 14b, e.g., the field of view 24 of the image sensor 14 may include the driver seat 34 and the second field of view 24b of the second image sensor 14b may include the passenger seat 36.

The system 12 may include a light source 52. The light source 52 can provide light to the footwell 22. The light source 52 can be a device that converts electricity into light, e.g., a light emitting diode, a laser, etc. The light source 52 may provide any suitable light detectable by the image sensor 14, e.g., visible light, infrared light, ultraviolet light, etc.

The light source 52 may be oriented to provide light to the footwell 22. For example, light from the light source 52 may travel from the light source 52 to the footwell 22. In other words, the light source 52 may be oriented to illuminate the footwell 22. The light source 52 may, for example, be disposed in the cabin 16. For example, the light source 52 may be disposed in the footwell 22. As another example, the light source 52 may be disposed out of the footwell 22 and face, i.e., be aimed at, the footwell 22.

The light source 52 may be mounted to any suitable vehicle component, e.g., the floor 38, the instrument panel 40, the center console 42, a door, etc. As another example, the light source 52 may be coupled to the reflector 18. In such an example, the light source 52 may be coupled to a back of the reflector 18, as shown in the Figures. In other words, the light source is disposed behind the reflector 18, e.g., to prevent or reduce glare from the light source 52 on the reflector 18. The light source 52 may be coupled to the reflector 18 in any suitable manner, e.g., fasteners, adhesive, etc.

The system 12 may include any suitable number of light sources 52. For example, the system 12 may include one light source 52 positioned to provide light to the footwell 22. As another example, the system 12 may include two light sources 52, each light source 52 positioned to provide light to one footwell 22a, 22b, respectively. As yet another example, the system 12 may include the same number of light sources 52 as reflectors 18.

The reflector 18 receives light that originated in the footwell 22 and is oriented to reflect light toward the image sensor 14. As used herein, oriented to reflect light toward the image sensor 14 means the reflector 18 is positioned such that light traveling at a specified angle relative to the reflector 18 is reflected by the reflector 18 to the image sensor 14, i.e., to the field of view 24 of the image sensor 14. In other words, the reflector 18 reflects the view 20 of the first footwell 22a to the image sensor 14, i.e., the field of view 24 of the image sensor 14. Reflecting light from the footwell 22 allows light to be provided to one or more image sensors 14 as data to detect objects such as the pedals 44, 46, a foot of a vehicle operator, packages, etc. in the footwell 22.

The reflector 18 may be a mirror. A mirror is any surface that reflects an image of visible light. The reflector 18 may include any suitable material or combination of materials, e.g., glass, plastic, metal, etc., that can reflect visible light. Additionally, or alternatively, the reflector 18 may reflect infrared light. In other words, the reflector 18 may include any suitable infrared-reflective materials, e.g., gold, aluminum, etc.

The reflector 18 may reflect the view 20 of the first footwell 22a to any suitable number of image sensors 14. For example, the reflector 18 may reflect the view 20 of the first footwell 22a into the field of view 24 of the image sensor 14, as shown in FIGS. 1A and 2A. As another example, the reflector 18 may reflect the view 20 of the first footwell 22a into the respective field of view 24 of a plurality of image sensors 14, e.g., into the field of view 24 of the image sensor 14 and into the second field of view 24b of the second image sensor 14b, as shown in FIG. 2A.

The reflector 18 may be disposed in any suitable position in the cabin 16. For example, the reflector 18 may be disposed in the footwell 22, as shown in FIGS. 1A and 2A. As another example, the reflector 18 may be disposed out of the footwell 22, as shown in FIGS. 3A and 4A. The reflector 18 may be disposed in a same or different position as the image sensor 14 relative to the footwell 22. For example, the reflector 18 and the image sensor 14 may each be disposed out of the footwell 22, as shown in FIGS. 3A and 4A. As another example, the reflector 18 and the image sensor 14 may each be disposed in the footwell 22. As yet another example, one of the reflector 18 and the image sensor 14 may be disposed in the footwell 22 and the other of the reflector 18 and the image sensor 14 may be disposed out of the footwell 22, as shown in FIGS. 1A and 2A.

The reflector 18 may be attached to a component in the cabin 16. For example, the reflector 18 may be fixedly mounted in a position to reflect the view 20 of the first footwell 22a regardless of how the field of view 24 of the image sensor 14 is adjusted. For another example, the reflector 18 may be movably mounted, e.g., by servomotors (not shown), and movement of the reflector 18 may track adjustment of the field of view 24 of the image sensor 14. The reflector 18 may be attached to any suitable component in the cabin 16, e.g., floor 38, the footwell 22, the center console 42, the door, the instrument panel 40, the roof beam 50, the seat, the body 30, etc. The reflector 18 may be attached to the vehicle component by any suitable means, e.g., fasteners, adhesive, etc.

The reflector 18 may be what is referred to as a primary reflector, i.e., the reflector 18 may be positioned to reflect light directly, i.e., without any intervening reflector 18, from the footwell 22 into the respective field of view 24 of at least one image sensor 14. In other words, the light may travel from the footwell 22 to the reflector 18 and may be reflected directly toward at least one image sensor 14. As another example, the reflector 18 may be what is referred to as an intermediate reflector, i.e., the reflector 18 may indirectly reflect the view 20 of the footwell 22 into the respective field of view 24 of at least one image sensor 14. For example, another reflector 18, referred to as an initial reflector, may reflect the view 20 of the footwell 22 to the intermediate reflector, and the reflector 18 may be positioned to reflect the reflected light from the footwell 22 toward at least one image sensor 14.

The system 12 may include any suitable number of reflectors 18. For example, as shown in FIG. 1A, the system 12 may include one reflector 18. As another example, the system 12 may include a plurality of reflectors, i.e., more than one, as shown in FIGS. 2A, 3A, and 4A. In this example, a first reflector 18 and a second reflector 18b each may be primary reflectors, as shown in FIG. 2A. As another example, a first reflector 18 may be an intermediate reflector, i.e., a second reflector 18b may reflect light to the first reflector 18, as shown in FIGS. 3A and 4A. In this example, the second reflector 18b is what is referred to as an initial reflector. In such an example, when more than one initial reflector reflects light to the intermediate reflector, one of the initial reflectors may be the second reflector 18b and another of the initial reflectors may be a third reflector 18c, as shown in FIG. 3A.

As seen in FIGS. 2A and 4A, the second reflector 18b is spaced from the first reflector 18, and, as shown in FIG. 3A, the third reflector 18c is spaced from both the reflector 18 and the second reflector 18b. The second reflector 18b may, for example, be positioned to reflect a view 54 of the second footwell 22b to the first reflector 18. As yet another example, the second reflector 18b may be positioned to reflect the view 54 of the second footwell 22b into the respective field of view 24 of at least one image sensor 14, as shown in FIG. 2A. As yet another example, the second reflector 18b may be positioned to reflect a second view 20b of the first footwell 22a into the respective field of view 24 of at least one image sensor 14, as shown in FIG. 2A. As yet another example, the second reflector 18b may be positioned to reflect the view 20 of the first footwell 22a to the reflector 18, as shown in FIGS. 3A and 4A. In this example, the third reflector 18c may, for example, be positioned to reflect the view 54 of the second footwell 22b to the reflector 18, as shown in FIG. 3A.

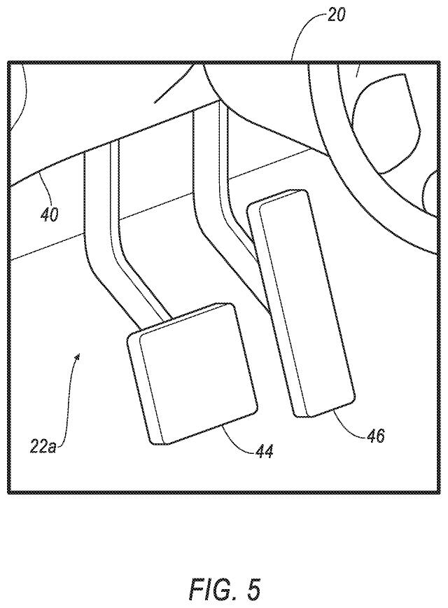

As shown in FIG. 5, the view 20 of the first footwell 22a includes the pedals 44, 46 and the relative position of the pedals 44, 46 in the first footwell 22a. For example, the view 20 of the first footwell 22a may include a foot position of the vehicle operator relative to the pedals 44, 46, i.e., a relative distance between a foot of the vehicle operator and at least one pedal 44, 46. In other words, the view 20 of the first footwell 22a may include the foot position of the vehicle operator within a predetermined area in the first footwell 22a. Additionally, the view 20 of the first footwell 22a may include objects disposed underneath the pedals 44, 46, i.e., positioned between the pedals 44, 46 and the floor 38 such that the objects may impede operation of at least one pedal 44, 46.

With reference to FIG. 2B, the second view 20b of the first footwell 22a may be referred to as an auxiliary view. For example, the reflector 18 and the second reflector 18b are each positioned to reflect the view 20 of the footwell 22. In this example, the second view 20b of the first footwell 22a is different from the view 20 of the first footwell 22a. In other words, the second view 20b of the first footwell 22a provides a different perspective of the first footwell 22a as compared to the view 20 of the first footwell 22a. Additionally, by providing auxiliary views of the footwell 22, the system 12 can detect the footwell 22, e.g., a foot position of the vehicle operator in the first footwell 22a, regardless of how the occupant is seated on the seat 34, 36. The view 20 of the first footwell 22a and the second view 20b of the first footwell 22a each may be reflected to a plurality of image sensors 14.

The view 54 of the second footwell 22b may include objects 56 disposed in the second footwell 22b. For example, the view 54 of the second footwell 22b may include packages, groceries, etc. disposed in the second footwell 22b. As another example, the view 54 of the second footwell 22b may include a foot position of a vehicle occupant, e.g., seated in the passenger seat 36, relative to objects 56 disposed in the second footwell 22b, e.g., to determine the occupant remains in the vehicle 10 with the objects 56, as set forth further below.

The system 12 may include any suitable combination of the reflectors 18 and image sensors 14. One embodiment is shown in FIGS. 1A and 1B, another embodiment is shown in FIGS. 2A-2C, another embodiment is shown in FIGS. 3A and 3B, and another embodiment is shown in FIGS. 4A and 4B. Common numerals are used to identify common features in the two embodiments.

In the embodiment shown in FIG. 1A, the system 12 may include the image sensor 14 and the reflector 18. With reference to FIG. 1A, the image sensor 14 may be attached to the roof beam 50 and the reflector 18 may be disposed in the first footwell 22a. In this example, the reflector 18 is positioned to reflect the view 20 of the first footwell 22a into the field of view 24 of the image sensor 14, as shown by broken lines in FIG. 1A.

With reference to FIG. 1B, the field of view 24 of the image sensor 14 may extend from one side 26 of the vehicle 10 to the other side 28 of the vehicle 10. The field of view 24 of the image sensor 14 may face forward, i.e., the front end 32 of the cabin 16 may be in the field of view 24. The field of view 24 of the image sensor 14 includes at least a portion of the front seats 34, 36, e.g., the seat bottoms. For example, the entire instrument panel 40 may be in the field of view 24 of the image sensor 14. The footwell 22, e.g., the pedals 44, 46, may be at least partially blocked from the field of view 24 of the image sensor 14, e.g., by the instrument panel 40. The reflector 18 is in the field of view 24 of the image sensor 14.

In the embodiment shown in FIG. 2A, the system 12 may include the image sensor 14, the second image sensor 14b, a first reflector 18, and three second reflectors 18b. With reference to FIG. 2A, the image sensor 14 and the reflector 18 each may be disposed in the same position as the embodiment shown in FIG. 1A. Additionally, like the embodiment shown in FIG. 1A, the first reflector 18 is positioned to reflect the view 20 of the first footwell 22a into the field of view 24 of the image sensor 14. In this embodiment, the second image sensor 14b may be disposed on one side 26 of the vehicle 10, e.g., adjacent to the driver seat 34. The first reflector 18 is also positioned to reflect the view 20 of the first footwell 22a into the second field of view 24b of the second image sensor 14b, as shown by broken lines in FIG. 2A.

In this embodiment, two second reflectors 18b are disposed in the first footwell 22a, and the other second reflector 18b is disposed in the second footwell 22b. The other second reflector 18b is positioned to reflect the view 54 of the second footwell 22b into the field of view 24 of the image sensor, as shown by broken lines in FIG. 2A.

Of the two second reflectors 18b disposed in the first footwell 22a, the second reflectors 18b may be spaced from each other. For example, one of the second reflectors 18b may be disposed adjacent one side 26 of the vehicle 10, and the other second reflector 18b may be disposed adjacent to the center console 42. The second reflectors 18b in the first footwell 22a may be positioned to reflect respective second views 20b of the first footwell 22a to respective image sensors 14, 14b. In other words, one of the second reflectors 18b in the first footwell 22a may be positioned to reflect the second view 20b of the first footwell 22a toward the image sensor 14, and the other of the second reflectors 18b in the first footwell 22a may be positioned to reflect the second view 20b of the first footwell 22a toward the second image sensor 14b, as shown by broken lines in FIG. 2A.

With reference to FIG. 2B, the field of view 24 of the image sensor 14 is the same as shown in FIG. 1B. In this embodiment, two of the second reflectors 18b are also in the field of view 24 of the image sensor 14. Specifically, the second reflectors 18 disposed adjacent to each side 26, 28 of the vehicle 10 are in the field of view 24 of the image sensor. In other words, the field of view 24 of the image sensor 14 may lack the second reflector 18 disposed in the first footwell 22a adjacent to the center console 42.

With reference to FIG. 2C, the second field of view 24b may extend partially across the front end 32 of the cabin 16. For example, the second field of view 24b may include the driver seat 34 and a portion of the instrument panel 40, i.e., the passenger seat 36 may be outside the second field of view 24b. The second field of view 24b of the second image sensor 14b may include a first reflector 18 and one second reflector 18b disposed in the first footwell 22a, e.g., the second reflector 18b disposed adjacent to the center console 42. In other words, the second field of view 24b of the second image sensor 14b may lack the second reflectors 18b disposed adjacent to the respective sides 26, 28 of the vehicle 10.

In the embodiment shown in FIG. 3A, the system 12 may include the image sensor 14, a first reflector 18, the second reflector 18b, and the third reflector 18c, as shown in FIG. 3A. In this embodiment, the image sensor 14 may be disposed on the instrument panel 40, e.g., at the center of the instrument panel 40, and face rearward, i.e., towards front seats 34, 36. The reflector 18 may be disposed rearward of the instrument panel 40. For example, the first reflector 18 may be mounted on the center console 42, e.g., between the front seats 34, 36, as shown in FIG. 3A. As another example, the first reflector 18 may be mounted on the roof beam 50. In this embodiment, the first reflector 18 may be an intermediate reflector. In other words, the second reflector 18b and the third reflector 18c each may be initial reflectors. The second reflector 18b may be disposed on one side 26 of the vehicle 10, e.g., in the first footwell 22a, on a driver door, etc., and the third reflector 18c may be disposed on the other side 28 of the vehicle 10, e.g., in the second footwell 22b, on a passenger door, etc. In this example, the second reflector 18b may be positioned to reflect the view 20 of the first footwell 22a to the reflector 18, and the third reflector 18c may be positioned to reflect the view 54 of the second footwell 22b to the reflector 18, as shown by broken lines in FIG. 3A. Additionally, the reflector 18 is positioned to reflect the view 20 of the first footwell 22a and the view 54 of the second footwell 22b into the field of view 24 of the image sensor 14, as shown by broken lines in FIG. 3A.

With reference to FIG. 3B, the field of view 24 of the image sensor 14 may extend across the cabin 16, i.e., from one side 26 of the vehicle 10 to the other side 28 of the vehicle 10. The field of view 24 of the image sensor may face rearward, i.e., toward the rear end of the cabin 16. In other words, the field of view 24 of the image sensor 14 may face away from the footwell 22. The field of view 24 of the image sensor 14 includes at least a portion of the front seats 34, 36, e.g., the seatbacks. The reflector 18 is disposed in the field of view 24 of the image sensor 14, and the second reflector 18 and the third reflector 18c are outside the field of view 24 of the image sensor 14.

In the embodiment shown in FIG. 4A, the system 12 may include the image sensor 14, a first reflector 18, and a second reflector 18b. In this embodiment, the image sensor 14 may be mounted on the instrument panel 40 adjacent to one side 26 of the vehicle 10. For example, the image sensor 14 may be positioned to face the driver seat 34. The first reflector 18 may, for example, be mounted adjacent to the driver seat 34, e.g., to a door, a B-pillar, etc. In this embodiment the first reflector 18 may be an intermediate reflector. The second reflector 18b may, for example, be disposed in the first footwell 22a, e.g., mounted to a side of the center console 42. In this embodiment, the second reflector 18b may be an initial reflector. The second reflector 18b may be positioned to reflect the view 20 of the first footwell 22a to the reflector 18, as shown by broken lines in FIG. 4A. Additionally, the first reflector 18 may be positioned to reflect the view 20 of the first footwell 22a as reflected by the second reflector 18b into the field of view 24 of the image sensor 14, as by broken lines in FIG. 4A.

With reference to FIG. 4B, the field of view 24 of the image sensor 14 may include a portion of the cabin 16. For example, the field of view 24 of the image sensor 14 may extend from one side 26 of the vehicle partially across the cabin 16. In this example, the field of view 24 of the image sensor 14 may include the driver seat 34, i.e., the field of view 24 of the image sensor 14 may lack the passenger seat 36. The field of view 24 of the image sensor 14 faces rearward, e.g., toward the rear end of the cabin 16. The reflector 18 is disposed in the field of view 24 of the image sensor 14, and the second reflector 18b is outside the field of view 24 of the image sensor 14.

The system 12 may include a computer (not shown). The computer may be a microprocessor-based computing device implemented via circuits, chips, or other electronic components. The computer includes a processor, memory, etc. The memory of the computer includes memory for storing instructions executable by the processor as well as for electronically storing data and/or databases.

The computer may transmit and receive data through a communications network such as a controller area network (CAN) bus, Ethernet, WiFi, Local Interconnect Network (LIN), onboard diagnostics connector (OBD-II), and/or by any other wired or wireless communications network. The computer may be in communication with the image sensors 14, the light source 52, and other components via the communications network.

The memory may store instructions executable by the processor to actuate a vehicle component based on capturing the view 20 of the footwell 22 reflected from the reflector 18. For example, the computer may receive information via the communication network from the image sensor 14 indicating the position of a foot of the vehicle operator relative to the pedals 44, 46. Based on the detected position of the foot of the vehicle operator, the computer may actuate the vehicle component. For example, when the detected foot position relative to the pedals 44, 46 is outside a predetermined area, e.g., too far for the vehicle operator to engage the pedal within a predetermined time, the computer may actuate a warning, e.g., an audio warning, a visual warning, a haptic warning, etc., to encourage adjustment of the foot position by the vehicle operator. As another example, when the detected foot position relative to the pedals 44, 46 is outside a predetermined area, e.g., too far for the vehicle operator to engage the pedal within a predetermined time, the computer may actuate one or more of the pedals 44, 46, i.e., the brake pedal 44, the accelerator 46, etc., to autonomously operate the vehicle 10. As another example, the computer may receive information via the communication network from the image sensor 14 indicating an object is in the first footwell 22a. Based on the detected object, the computer may actuate a warning, e.g., e.g., an audio warning, a visual warning, a haptic warning, etc., to alert the vehicle operator to a potential impediment to the operation of the pedals 44, 46. Alternatively, the computer may autonomously operate the vehicle 10 until the object impeding operation of the pedals 44, 46 is removed. As another example, the computer may receive information via the communication network from the image sensor 14 indicating an object 56 is in the second footwell 22b, e.g., after an occupant exits the vehicle 10. Based on the detected object 56, the computer may actuate a warning, e.g., an audio warning, a visual warning, a haptic warning, etc., to remind the occupant to collect the object 56.

Computing devices, such as the computer, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A system comprising:
an image sensor disposed in a vehicle cabin; and
a reflector disposed in the cabin and positioned to reflect a view of a footwell into a field of view of the image sensor.

2. The system of claim 1, wherein the reflector is disposed in the footwell.

3. The system of claim 2, wherein the image sensor is disposed in the footwell.

4. The system of claim 2, wherein the image sensor is out of the footwell.

5. The system of claim 2, further comprising a light source disposed in the footwell.

6. The system of claim 5, wherein the light source is coupled to the reflector.

7. The system of claim 1, wherein the reflector and the image sensor are out of the footwell.

8. The system of claim 7, further comprising a light source disposed in the footwell.

9. The system of claim 1, further comprising pedals disposed in the footwell, the view of the footwell including the pedals.

10. The system of claim 1, further comprising a processor and a memory storing instructions executable by the processor to actuate a vehicle component based on capturing the view of the footwell reflected from the reflector.

11. The system of claim 1, further comprising:
a second image sensor spaced from the image sensor and having a second field of view, and
a second reflector disposed in the cabin and positioned to reflect a second view of the footwell into the second field of view.

12. The system of claim 1, further comprising a second reflector disposed in the cabin and spaced from the reflector, wherein the second reflector is positioned to reflect a second view of the footwell into the field of view of the image sensor.

13. The system of claim 1, further comprising a second image sensor spaced from the image sensor and including a second field of view, wherein the reflector is positioned to reflect the view of the footwell into the second field of view of the second image sensor.

14. The system of claim 1, further comprising a second reflector disposed in the cabin and spaced from the reflector, wherein the second reflector is positioned to reflect the view of the footwell to the reflector.

15. The system of claim 14, further comprising a second footwell spaced from the footwell and a third reflector disposed in the cabin, the third reflector positioned to reflect a view of the second footwell to the reflector, wherein the reflector is positioned to reflect the view of the second footwell into the field of view of the image sensor.

16. The system of claim 1, further comprising a second footwell spaced from the footwell, and a second reflector disposed in the cabin and positioned to reflect a view of the second footwell into the field of view of the image sensor.

17. The system of claim 1, wherein the image sensor is an infrared image sensor.

18. The system of claim 1, wherein the reflector includes infrared-reflective material.

19. The system of claim 1, wherein the image sensor is a visible-light camera.

20. The system of claim 1, wherein the reflector is a mirror.
